(19) United States
(12) Patent Application Publication
(10) Pub. No.: US 2025/0064285 A1
(43) Pub. Date: Feb. 27, 2025

(54) Vacuum Cleaner

(71) Applicant: SUZHOU ALTON ELECTRICAL & MECHANICAL INDUSTRY CO., LTD., Suzhou, Jiangsu (CN)

(72) Inventors: Weidong LU, West Chicago, IL (US); Jinbo LIU, Suzhou, Jiangsu (CN); Menghuan ZHANG, Suzhou, Jiangsu (CN); Shuhua SANG, Suzhou, Jiangsu (CN)

(21) Appl. No.: 18/723,860

(22) PCT Filed: Nov. 23, 2022
(86) PCT No.: PCT/CN2022/133677

§ 371 Date: Jun. 24, 2024

(30) Foreign Application Priority Data
Dec. 26, 2021 (CN) 202111606702.0

(51) Int. Cl. A47L 9/28; A47L 9/00

(52) U.S. Cl. CPC A47L 9/2889; A47L 9/0081

(57) ABSTRACT

Disclosed is a vacuum cleaner, including a dust collecting barrel, a machine head, a first buckle and a second buckle, the dust collecting barrel and the machine head are detachably assembled together by the first buckle and the second buckle, the machine head is provided with a motor, an air inlet window, an air outlet window, a first silencing member and a second silencing member, the air inlet window and the air outlet window are located on left and right sides of the machine head, a heat dissipation airflow for the motor enters the machine head through the air inlet window and is exhausted out of the machine head through the air outlet window, and the heat dissipation airflow passes through the air inlet window, the first silencing member, an interior of the motor, the second silencing member and the air outlet window in sequence.

### CROSS-REFERENCE TO RELATED APPLICATION

The disclosure is a National Stage Filing of the PCT International Application No. PCT/CN2022/133677 filed on Nov. 23, 2022, which claims priority to the benefit of Chinese Patent Application No. 202111606702.0, filed to the China National Intellectual Property Administration (CNIPA) on Dec. 26, 2021, which is hereby incorporated by reference in its entirety.

### TECHNICAL FIELD

The disclosure relates to a vacuum cleaner, for example, relates to a heat dissipation and noise reduction of a motor.

### BACKGROUND

Chinese patent CN2017201210716 discloses a vacuum cleaner, which is provided with a machine head, a dust collecting barrel, a first buckle and a second buckle, the first buckle and the second buckle are located on left and right sides of the dust collecting barrel, the first buckle and the second buckle are respectively movably connected to the dust collecting barrel, the machine head and the dust collecting barrel are detachably assembled together by the first buckle and the second buckle, the machine head is provided with a motor, a first concave portion corresponding to the first buckle and a second concave portion corresponding to the second buckle, the first concave portion and the second concave portion are located on left and right sides of the machine head, the first buckle is partially accommodated in the first concave portion, the second buckle is partially accommodated in the second concave portion, the first concave portion and the second concave portion are respectively provided with an air inlet window, the machine head is further provided with an air outlet window located on a rear side of the machine head, a heat dissipation airflow for the motor enters the machine head through the air inlet window of the first concave portion and the air inlet window of the second concave portion and is exhausted out of the machine head through the air outlet window on the rear side of the machine head, and layout of the heat dissipation air inlet and outlet windows of the motor and noise reduction design need to be improved.

### SUMMARY

The disclosure provides a vacuum cleaner, which is beneficial to efficient heat dissipation of a motor thereof and reduces noise spread by a heat dissipation airflow of the motor.

The disclosure provides a vacuum cleaner, including a dust collecting barrel, a machine head, a first buckle and a second buckle, the dust collecting barrel and the machine head are detachably assembled together by the first buckle and the second buckle, the machine head is provided with a motor, an air inlet window and an air outlet window, a first silencing member which is breathable and corresponds to the air inlet window and a second silencing member which is breathable and corresponds to the air outlet window, the air inlet window and the air outlet window are located on left and right sides of the machine head, a heat dissipation airflow for the motor enters the machine head through the air inlet window located on one of left and right sides of the machine head and is exhausted out of the machine head through the air outlet window located on the other of left and right sides of the machine head, and the heat dissipation airflow passes through the air inlet window, the first silencing member, an interior of the motor, the second silencing member and the air outlet window in sequence.

In some embodiments, the first buckle and the second buckle are located on left and right sides of the machine head, the machine head is further provided with a first concave portion corresponding to the first buckle and a second concave portion corresponding to the second buckle, the first concave portion and the second concave portion are located on left and right sides of the machine head, the first buckle is at least partially accommodated in the first concave portion, the second buckle is at least partially accommodated in the second concave portion, the first concave portion is provided with the air inlet window, the second concave portion is provided with the air outlet window, the first silencing member is located on a side, facing away from the first buckle, of the air inlet window, and the second silencing member is located on a side, facing away from the second buckle, of the air outlet window.

In some embodiments, the first silencing member is plate-shaped and is shielded on an inner side of the air inlet window, and the second silencing member is plate-shaped and is shielded on an inner side of the air outlet window.

In some embodiments, the machine head is further provided with an outer shell and a handle, the handle is connected to the outer shell, the first concave portion and the second concave portion are parts of the outer shell respectively, the air inlet window and the air outlet window are located on left and right sides of the outer shell, the outer shell is provided with a first extension portion configured for fixing the first silencing member and a second extension portion configured for fixing the second silencing member, the first extension portion and the air inlet window clamp the first silencing member, and the second extension portion and the air outlet window clamp the second silencing member.

In some embodiments, the air inlet window is provided with a plurality of first grid plates in parallel, the plurality of first grid plates are located on the side, facing away from the first buckle, of the air inlet window, the air outlet window is provided with a plurality of second grid plates in parallel, the plurality of second grid plates are located on the side, facing away from the second buckle, of the air outlet window, the first extension portion and the plurality of first grid plates clamp the first silencing member, and the second extension portion and the plurality of second grid plates clamp the second silencing member.

In some embodiments, the machine head is further provided with an outer shell, the outer shell is provided with a first protrusion portion and a second protrusion portion on left and right sides of the outer shell, the first protrusion portion is located on a side, corresponding to the first buckle, of the outer shell, the second protrusion portion is located on a side, corresponding to the second buckle, of the outer shell, the first concave portion is concavely arranged on the first protrusion portion, the second concave portion is concavely arranged on the second protrusion portion, the first silencing member is located inside the first protrusion portion, and the second silencing member is located inside the second protrusion portion.

In some embodiments, the first protrusion portion is provided with a first outer side wall and a second outer side wall on two opposite sides, the first outer side wall and the second outer side wall are located on two opposite sides of the air inlet window, the first silencing member is located between the first outer side wall and the second outer side wall, the first silencing member is plate-shaped facing the air inlet window, a side edge of the first silencing member abuts on the first outer side wall, and an opposite side edge of the first silencing member abuts on the second outer side wall; and the second protrusion portion is provided with a third outer side wall and a fourth outer side wall on two opposite sides, the third outer side wall and the fourth outer side wall are located on two opposite sides of the air outlet window, the second silencing member is located between the third outer side wall and the fourth outer side wall, the second silencing member is plate-shaped facing the air outlet window, one side edge of the second silencing member abuts on the third outer side wall, and the other opposite side edge of the second silencing member abuts on the fourth outer side wall.

In some embodiments, the machine head is further provided with a lower cover, the lower cover covers an upper end of the dust collecting barrel, the first buckle is buckled at an edge of one side of the lower cover, the second buckle is buckled at an edge of the other opposite side of the lower cover, the outer shell is mounted at an upper side of the lower cover, the first protrusion portion is further provided with a first top wall located on its top, the first top wall is integrally connected to a top end of the air inlet window, a top end of the first outer side wall, and a top end of the second outer side wall; an upper side edge of the first silencing member abuts on the first top wall, and a bottom side edge of the first silencing member abuts on the lower cover; and the second protrusion portion is further provided with a second top wall located on its top, the second top wall is integrally connected to a top end of the air outlet window, a top end of the third outer side wall, and a top end of the fourth outer side wall; an upper side edge of the second silencing member abuts on the second top wall, and a bottom side edge of the second silencing member abuts on the lower cover.

In some embodiments, the first silencing member and the second silencing member are respectively upright arranged on the upper side of the lower cover, and a lower end of the first outer side wall, a lower end of the second outer side wall, a lower end of the third outer side wall, a lower end of the fourth outer side wall, a lower end of the air inlet window, and a lower end of the air outlet window are respectively attached to the lower cover.

In some embodiments, the first protrusion portion is further provided with a first top wall located on its top, the second protrusion portion is further provided with a second top wall located on its top, the first silencing member and the air inlet window are located on a lower side of the first top wall, the second silencing member and the air outlet window are located on a lower side of the second top wall, the outer shell is provided with a first extension portion configured for fixing the first silencing member and a second extension portion configured for fixing the second silencing member, the first extension portion is located inside the first protrusion portion and integrally extends downwards from the first top wall, and the second extension portion is located inside the second protrusion portion and integrally extends downwards from the second top wall.

In some embodiments, the motor is provided with a heat dissipation air inlet and a heat dissipation air outlet, a heat dissipation air duct is formed in the machine head, the heat dissipation airflow enters the motor through the heat dissipation air inlet and is exhausted out of the motor through the heat dissipation air outlet and flows into the heat dissipation air duct, an end of the heat dissipation air duct is provided with an air outlet, and the air outlet window is located at a downstream of the air outlet of the heat dissipation air duct.

In some embodiments, the machine head is further provided with a first concave portion corresponding to the first buckle, a second concave portion corresponding to the second buckle, a first protrusion portion corresponding to the first buckle, and a second protrusion portion corresponding to the second buckle, the first concave portion is concavely arranged on the first protrusion portion, the second concave portion is concavely arranged on the second protrusion portion, and the heat dissipation air duct is in fluid communication between the heat dissipation air outlet of the motor and an interior of the second protrusion portion.

In some embodiments, the air outlet of the heat dissipation air duct and the air outlet window are located on left and right sides of the second protrusion portion, the air outlet of the heat dissipation air duct is toward the air outlet window, the air outlet of the heat dissipation air duct directly communicates with the interior of the second protrusion portion.

In some embodiments, the machine head is provided with a heat dissipation air hood configured for forming the heat dissipation air duct, the air outlet of the heat dissipation air duct is located at an end, relatively close to the air outlet window, of the heat dissipation air hood, the heat dissipation air hood is provided with a shield plate, the heat dissipation air inlet of the motor is located on a top of the motor, and the shield plate is located above the heat dissipation air inlet, and a projection formed by vertical downward projection of the shield plate completely covers the heat dissipation air inlet.

In some embodiments, the machine head is further provided with a vibration damping seal washer, the heat dissipation air hood is provided with a sleeve ring portion and a vent, the shield plate is located on an upper side of the sleeve ring portion, the vent is formed between the sleeve ring portion and the shield plate, the vibration damping seal washer is sleeved on an upper end of the motor and is sealed between a peripheral edge of the upper end of the motor and the sleeve ring portion for isolating the heat dissipation air inlet of the motor from the heat dissipation air duct, and the heat dissipation airflow flows toward the heat dissipation air inlet through the vent.

In some embodiments, the machine head is further provided with an outer shell, a third silencing member, a first concave portion corresponding to the first buckle, and a second concave portion corresponding to the second buckle, the first concave portion and the second concave portion are respectively parts of the outer shell, the heat dissipation air hood is located in the outer shell, the third silencing member is plate-shaped abutting on an inner surface of the outer shell and is located above the heat dissipation air hood, the shield plate upwardly abuts on the third silencing member.

In some embodiments, the machine head is further provided with a lower cover, an exhaust air hood, an impeller, a first concave portion corresponding to the first buckle, and a second concave portion corresponding to the second buckle, the impeller is located below the motor, the impeller rotates under driving of the motor to form a suction airflow, the exhaust air hood is located on an upper side of the lower cover, an exhaust air duct is formed between the exhaust air hood and the lower cover, the exhaust air duct surrounds an axis of a rotating shaft of the motor, and an airflow exhausted by the impeller flows through the exhaust air duct; and the lower cover is provided with a first part located on a bottom side of the first concave portion, and a second part located on a bottom side of the second concave portion, the first buckle is buckled on the first part, and the second buckle is buckled on the second part.

In some embodiments, the first part is provided with a first stop rib, the first stop rib protrudes inwards the first concave portion, and the first stop rib is configured to fit with the first buckle to prevent a buckling fit between the first buckle and the first part from being disengaged; and the second part is provided with a second stop rib, the second stop rib protrudes inwards the second concave portion, and the second stop rib is configured to fit with the second buckle to prevent a buckling fit between the second buckle and the second part from being disengaged.

In some embodiments, the machine head is further provided with a heat dissipation air hood and an outer shell, the heat dissipation air hood is located on an upper side of the exhaust air hood, and the heat dissipation air duct is formed among the heat dissipation air hood, the exhaust air hood and the lower cover; and the first concave portion and the second concave portion are respectively parts of the outer shell, the heat dissipation air hood and the exhaust air hood are located between the outer shell and the lower cover, and the outer shell is located on the upper side of the lower cover and covers the heat dissipation air hood and the exhaust air hood.

In some embodiments, the heat dissipation air outlet of the motor is located on a bottom side of the motor, the heat dissipation air duct includes an annular part surrounding the motor, and a lead-out part located at a downstream of the annular part, and with respect to the air outlet window, the air outlet of the heat dissipation air duct is located at an end, relatively close to the air outlet window, of the lead-out part; and with respect to the annular part, the air outlet of the heat dissipation air duct is located at an end, relatively away from the annular part, of the lead-out part.

In some embodiments, the first concave portion is formed with a first groove, the second concave portion is formed with a second groove, the first groove is located on a side, facing the first buckle, of the air inlet window, the second groove is located on a side, facing the second buckle, of the air outlet window, the air inlet window directly communicates with an interior of the first protrusion portion and the first groove, and the air outlet window directly communicates with an interior of the second protrusion portion and the second groove; and the heat dissipation airflow enters the first protrusion portion through the first groove and the air inlet window in sequence and passes through the first silencing member inside the first protrusion portion, the heat dissipation airflow downwardly passes through the interior of the motor from the heat dissipation air inlet and flows out of the motor from the heat dissipation air outlet on a bottom side of the motor; after flowing out from the heat dissipation air outlet, the heat dissipation airflow enters the annular part of the heat dissipation air duct, the heat dissipation airflow upwardly flows to an upper part of the annular part and is converged into the lead-out part of the heat dissipation air duct, and is exhausted out of the heat dissipation air duct through the air outlet of the heat dissipation air duct and enters the second protrusion portion, and the heat dissipation airflow passes through the second silencing member inside the second protrusion portion and is exhausted through the air outlet window.

In some embodiments, the air inlet window faces the first buckle, and the air outlet window faces the second buckle; the first concave portion is formed with a first groove, the second concave portion is formed with a second groove, the first buckle is at least partially accommodated in the first groove, the second buckle is at least partially accommodated in the second groove, the first groove is located on a side, facing the first buckle, of the air inlet window, the second groove is located on a side, facing the second buckle, of the air outlet window, the air inlet window directly communicates with an interior of the machine head and the first groove, and the air outlet window directly communicates with the interior of the machine head and the second groove.

In some embodiments, the machine head is further provided with an outer shell, the outer shell is further provided with a first protrusion portion and a second protrusion portion on two opposite sides of the outer shell, the first protrusion portion is located on a side, corresponding to the first buckle, of the outer shell, the second protrusion portion is located on a side, corresponding to the second buckle, of the outer shell, the first concave portion is concavely arranged on the first protrusion portion, the second concave portion is concavely arranged on the second protrusion portion, the air inlet window directly communicates with an interior of the first protrusion portion and the first groove, and the air outlet window directly communicates with an interior of the second protrusion portion and the second groove.

In some embodiments, the first groove and the second groove extend along an up-down direction, the first concave portion is provided with a first vertical side wall and a second vertical side wall, the second concave portion is provided with a third vertical side wall and a fourth vertical side wall, the air inlet window is connected between the first vertical side wall and the second vertical side wall, the first vertical side wall, the air inlet window and the second vertical side wall are connected together to form the first groove, the air outlet window is connected between the third vertical side wall and the fourth vertical side wall, and the third vertical side wall, the air outlet window and the fourth vertical side wall are connected together to form the second groove.

In some embodiments, the motor is provided with a heat dissipation air inlet and a heat dissipation air outlet, a heat dissipation air duct is formed in the machine head, the heat dissipation airflow enters the first protrusion portion through the first groove and the air inlet window in sequence and passes through the first silencing member inside the first protrusion portion, the heat dissipation airflow enters the motor from the heat dissipation air inlet and is exhausted out of the motor from the heat dissipation air outlet and flows into the heat dissipation air duct, the heat dissipation airflow is exhausted out of the heat dissipation air duct through an air outlet of the heat dissipation air duct and enters the second protrusion portion, and the heat dissipation airflow passes through the second silencing member inside the second protrusion portion and is exhausted out of the machine head through the air outlet window.

In some embodiments, the motor is provided with a heat dissipation fan, and the heat dissipation fan rotates to form the heat dissipation airflow; the first buckle is pivotally connected on one side of the dust collecting barrel, the second buckle is pivotally connected on the other opposite side of the dust collecting barrel; the first buckle is partially accommodated in the first groove, the second buckle is partially accommodated in the second groove; the first buckle is provided with a first main board portion, the second buckle is provided with a second main board portion, the first main board portion faces the air inlet window, the first main board portion is opposite to the air inlet window at an interval, and an upper end of the first buckle and an upper end of the first concave portion are enclosed to form a first opening; and the second main board portion faces the air outlet window, the second main board portion is opposite to the air outlet window at an interval, an upper end of the second buckle and an upper end of the second concave portion are enclosed to form a second opening, the first opening and the second opening face upwards respectively, and at least part of the heat dissipation airflow exhausted through the air outlet window flows upwards out of the second opening.

In the disclosure, an air inlet window and an air outlet window for heat dissipation of a motor are arranged on left and right sides of a machine head, a heat dissipation airflow enters from the air inlet window on one of left and right sides of the machine head and exits from the air outlet window on the other of left and right sides of the machine head, in short, the heat dissipation airflow flows from one of left and right sides of the machine head to the other of left and right sides of the machine head in a penetrating manner, a relatively cold inlet air of the air inlet window and a relatively hot outlet air of the air outlet window are fully separated, a mutual interference of the relatively cold inlet air and the relatively hot outlet air is effectively avoided, an improvement of heat dissipation efficiency of the motor is promoted, and meanwhile, noise spread on the heat dissipation airflow path of the motor is reduced by utilizing a first silencing member which is breathable and corresponds to the air inlet window and a second silencing member which is breathable and corresponds to the air outlet window. To sum up, the layout of the heat dissipation air inlet and outlet windows of the motor is practical, efficient heat dissipation of the motor is facilitated, and noise spread by heat dissipation airflow of the motor is reduced. In the disclosure, a first concave portion and a second concave portion for at least partially accommodating a first buckle and a second buckle correspondingly on opposite sides of the machine head are effectively utilized for arranging the air inlet window and the air outlet window for heat dissipation of the motor, so that the first concave portion and the second concave portion form an in-out relationship, expanding an overall use of the first concave portion and the second concave portion and facilitating an avoidance of forming the air inlet window and the air outlet window for heat dissipation of the motor at the positions other than the first concave portion and the second concave portion of the machine head.

### BRIEF DESCRIPTION OF THE DRAWINGS

FIG. 1 is a three-dimensional diagram of a vacuum cleaner of the disclosure.

FIG. 2 is a three-dimensional diagram of a motor of a vacuum cleaner of the disclosure.

FIG. 3 is a vertical sectional view of a machine head and a filter, in a combined state, of a vacuum cleaner of the disclosure.

FIG. 4 is an upward view of a machine head, after a lower cover thereof is removed, of a vacuum cleaner of the disclosure.

FIG. 5 is a three-dimensional diagram of a machine head, after an outer shell and a handle are removed, of a vacuum cleaner of the disclosure.

FIG. 6 is an exploded view of a machine head of a vacuum cleaner of the disclosure (with part of components not shown).

FIG. 7 is another exploded view of a machine head of a vacuum cleaner of the disclosure (with part of components not shown).

FIG. 8 is a three-dimensional diagram of a second buckle of a vacuum cleaner of the disclosure.

FIG. 9 is another three-dimensional diagram of a vacuum cleaner of the disclosure.

### DETAILED DESCRIPTION OF THE EMBODIMENTS

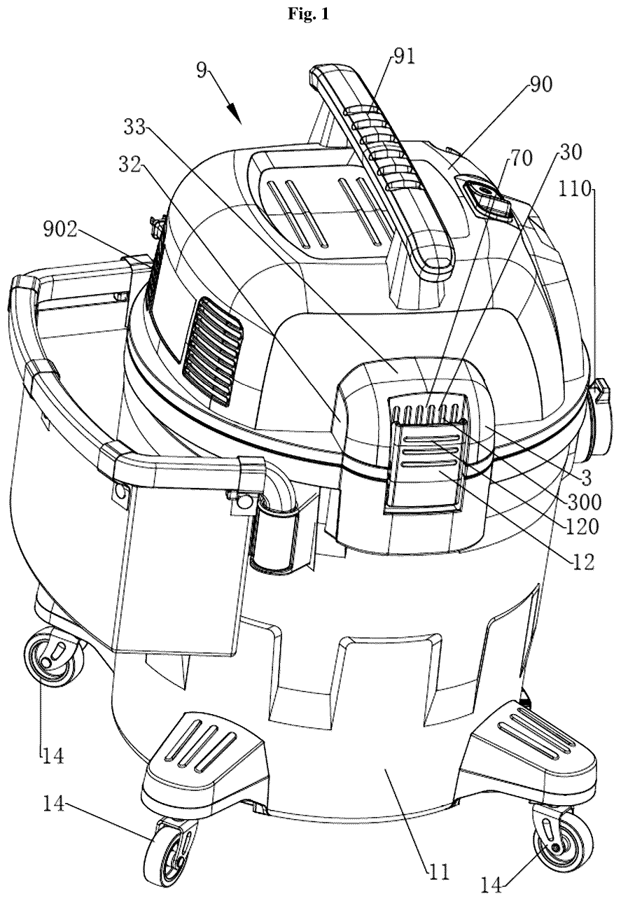

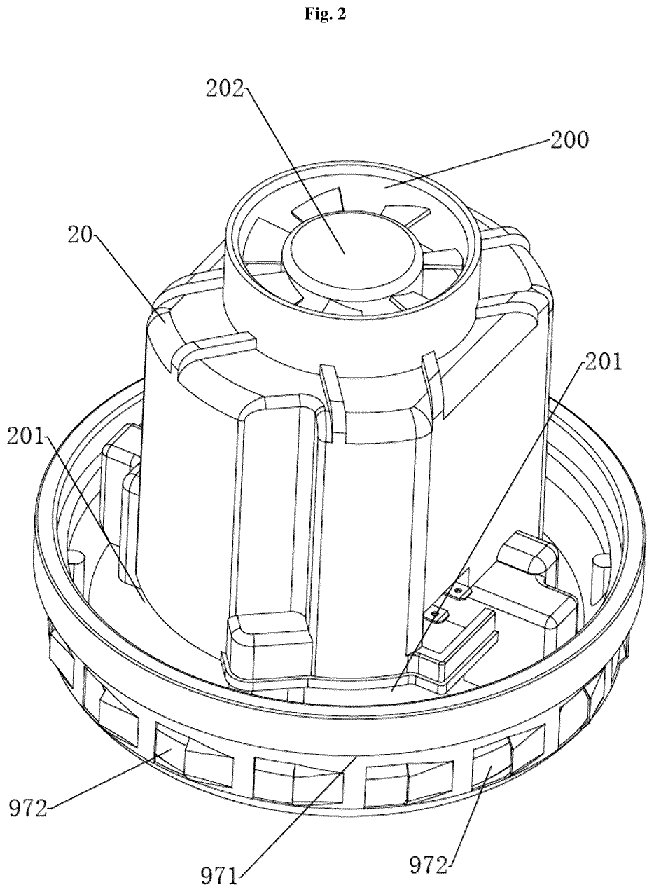

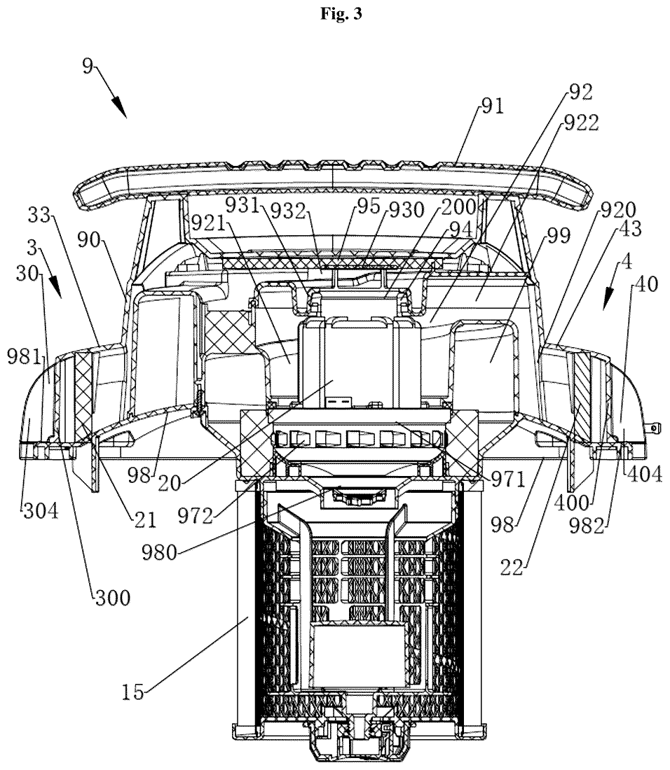

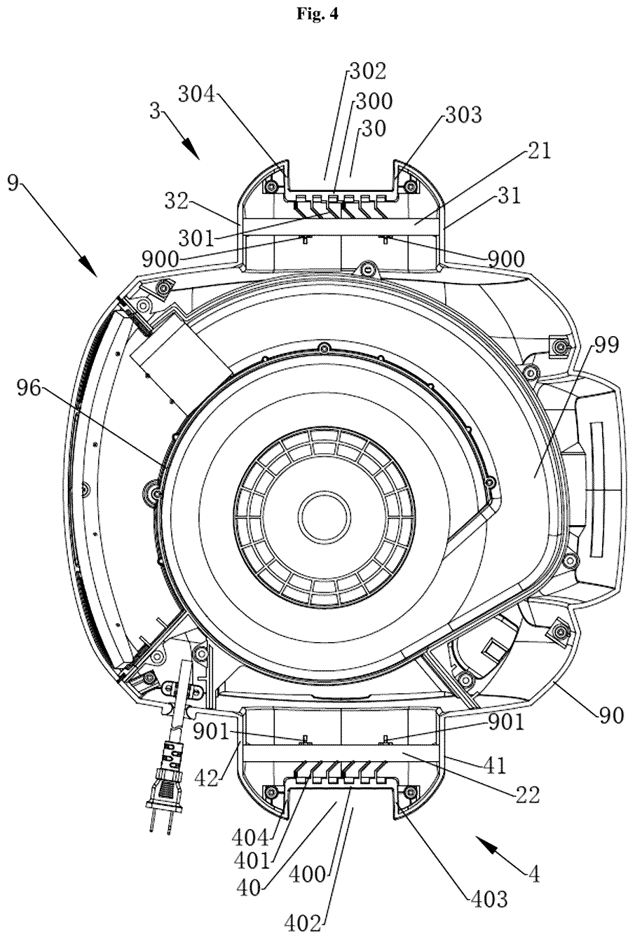

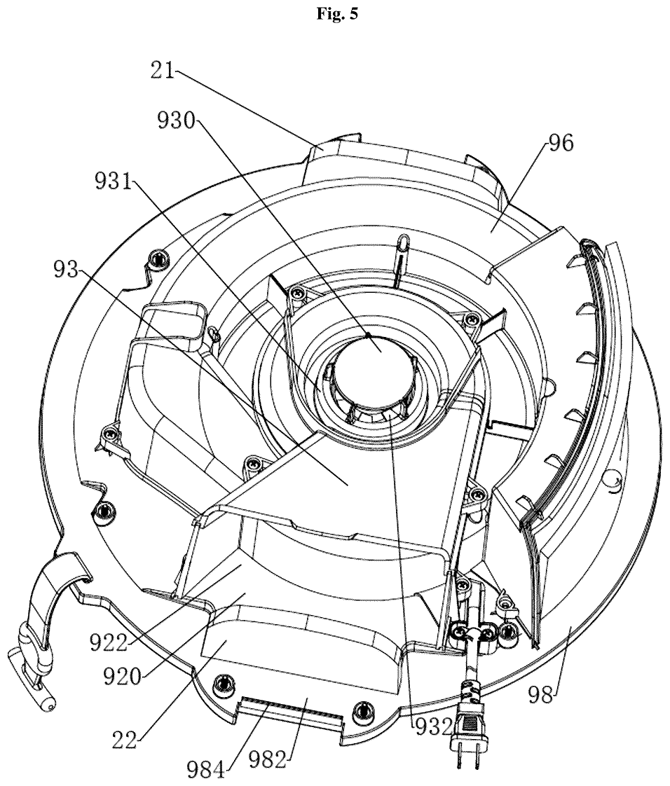

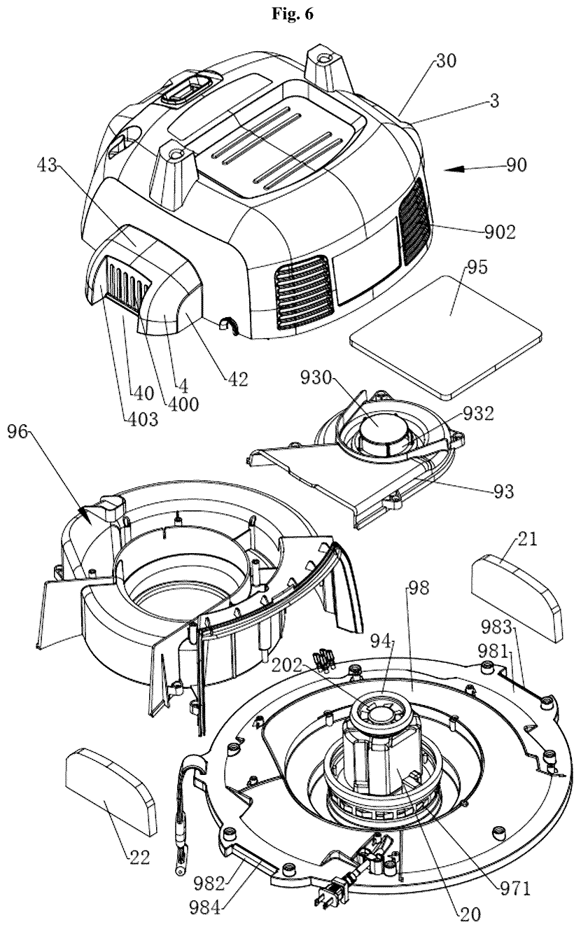

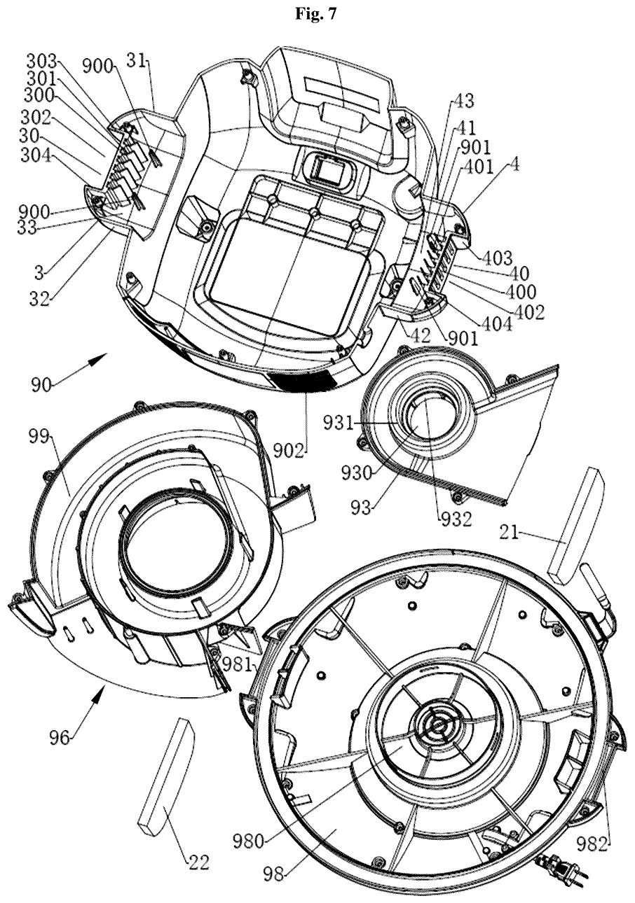

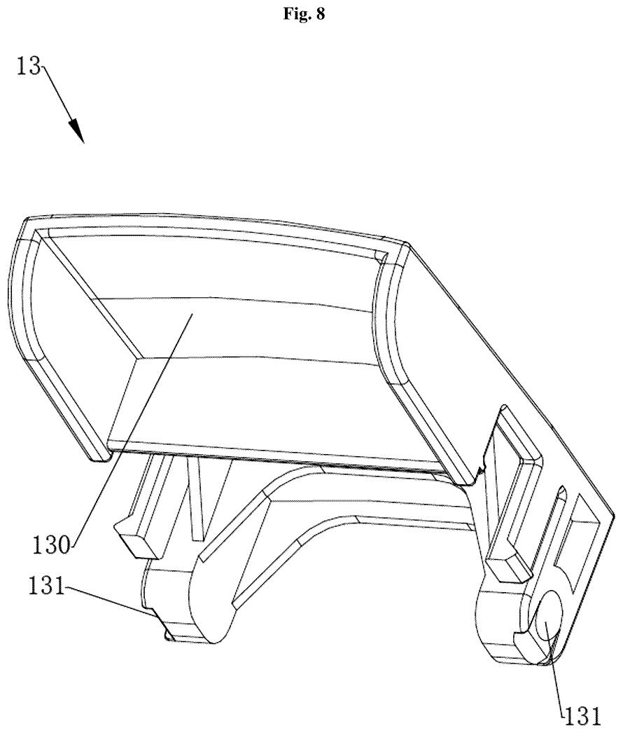

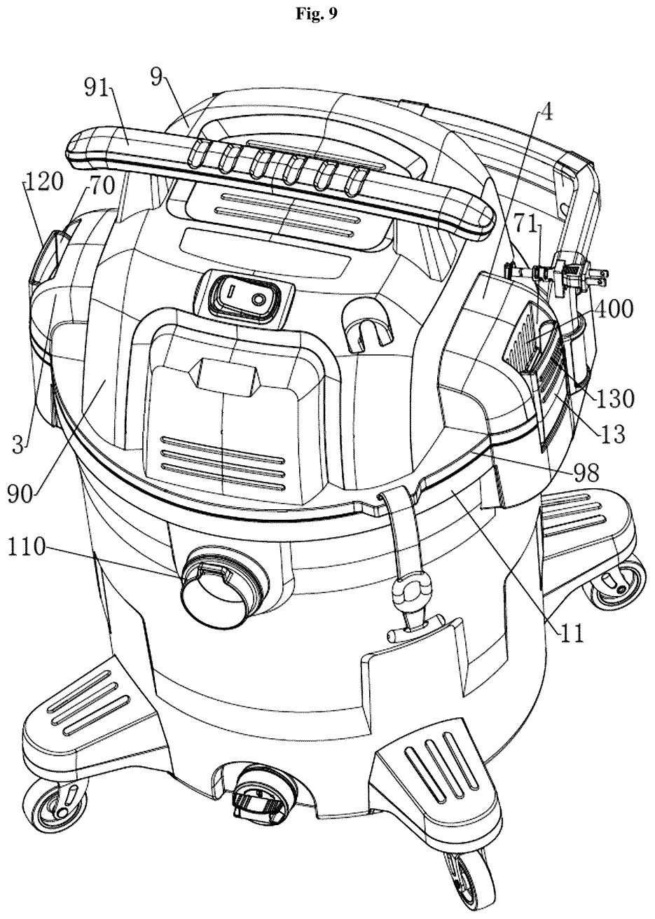

As shown in FIGS. 1-9, a vacuum cleaner of the disclosure includes a machine head 9, a dust collecting barrel 11, a first buckle 12 and a second buckle 13, the first buckle 12 and the second buckle 13 are located on two opposite sides of the dust collecting barrel 11, the first buckle 12 and the second buckle 13 are respectively movably connected to the dust collecting barrel 11, and the machine head 9 and the dust collecting barrel 11 are detachably assembled together by the first buckle 12 and the second buckle 13; and the machine head 9 is provided with a motor 20, a first concave portion 30 and a second concave portion 40, the first concave portion 30 and the second concave portion 40 are located on two opposite sides of the machine head 9, the first buckle 12 is at least partially accommodated in the first concave portion 30, the second buckle 13 is at least partially accommodated in the second concave portion 40, the first concave portion 30 is provided with an air inlet window 300, the second concave portion 40 is provided with an air outlet window 400, and a heat dissipation airflow for the motor 20 enters the machine head 9 through the air inlet window 300 and is exhausted out of the machine head 9 through the air outlet window 400. In such layout, the first concave portion 30 and the second concave portion 40 for at least partially accommodating the first buckle 12 and the second buckle 13 correspondingly on two opposite sides of the machine head 9 are effectively utilized for arranging the air inlet window 300 and the air outlet window 400 for heat dissipation of the motor 20, so that the first concave portion 30 and the second concave portion 40 form an in-out relationship, expanding an overall use of the first concave portion 30 and the second concave portion 40 and facilitating an avoidance of forming the air inlet and outlet windows 300, 400 for heat dissipation of the motor 20 at the positions rather than the first concave portion 30 and the second concave portion 40 of the machine head 9, to sum up, the layout of the air inlet and outlet windows 300, 400 for heat dissipation of the motor 20 is practical; the heat dissipation airflow enters from the air inlet window 300 of the first concave portion 30 on one side of the machine head 9 and exits from the air outlet window 400 of the second concave portion 40 on the other side of the machine head 9, in short, the heat dissipation airflow flows from one side of the machine head 9 to the opposite other side of the machine head 9 in a penetrating manner, a relatively cold inlet air of the air inlet window 300 and a relatively hot outlet air of the air outlet window 400 are located on two opposite sides of the machine head 9, so as to be fully separated, a mutual interference is avoided, and an improvement of heat dissipation efficiency of the motor 20 is promoted; and to sum up, the layout of the air inlet and outlet windows 300, 400 for heat dissipation of the motor 20 of the disclosure is practical, and efficient heat dissipation is facilitated.

The air inlet window 300 faces the first buckle 12, and the air outlet window 400 faces the second buckle 13; a rated power of the motor 20 is 90 w-3100 w, and in an embodiment, the rated power of the motor 20 is 1800 w-2000 w; and a capacity of the dust collecting barrel 11 is 0.6 gallons-40 gallons, and in an embodiment, the capacity of the dust collecting barrel 11 is 1 gallons-19 gallons. A wheel 14 is arranged at a bottom side of the dust collecting barrel 11.

The machine head 9 is further provided with a first silencing member 21 which is breathable and corresponds to the air inlet window 300 and a second silencing member 22 which is breathable and corresponds to the air outlet window 400, the first silencing member 21 is located on a side, facing away from the first buckle 12, of the air inlet window 300, and the second silencing member 22 is located on a side, facing away from the second buckle 13, of the air outlet window 400. Such arrangement is able to effectively reduce noise generated by the heat dissipation airflow of the motor 20. The first silencing member 21 abuts on the air inlet window 300, and the second silencing member 22 abuts on the air outlet window 400. The first silencing member 21 is plate-shaped and is shielded on an inner side of the air inlet window 300, the second silencing member 22 is plate-shaped and is shielded on an inner side of the air outlet window 400, and the heat dissipation airflow sequentially passes through the air inlet window 300, the first silencing member 21, the interior of the motor 20, the second silencing member 22 and the air outlet window 400. The first silencing member 21 completely shields the air inlet window 300 on the inner side of the air inlet window 300, and the second silencing member 22 completely shields the air outlet window 400 on the inner side of the air outlet window 400.

The machine head 9 is further provided with an outer shell 90 and a handle 91, the outer shell 90 is exposed to an outer side of the machine head 9, the handle 91 is connected to the outer shell 90, the first concave portion 30 and the second concave portion 40 are parts of the outer shell 90 respectively, the air inlet window 300 and the air outlet window 400 are located on two opposite sides of the outer shell 90, the outer shell 90 is provided with a first extension portion 900 configured for fixing the first silencing member 21 and a second extension portion 901 configured for fixing the second silencing member 22, the first extension portion 900 and the air inlet window 300 clamp the first silencing member 21, and the second extension portion 901 and the air outlet window 400 clamp the second silencing member 22. The air inlet window 300 and the air outlet window 400 are integrally formed on the outer shell 90 respectively.

The air inlet window 300 is provided with a plurality of first grid plates 301 in parallel, the plurality of first grid plates 301 are located on the side, facing away from the first buckle 12, of the air inlet window 300, the air outlet window 400 is provided with a plurality of second grid plates 401 in parallel, the plurality of second grid plates 401 are located on the side, facing away from the second buckle 13, of the air outlet window 400, the first extension portion 900 and the plurality of first grid plates 301 clamp the first silencing member 21, and the second extension portion 901 and the plurality of second grid plates 401 clamp the second silencing member 22. The first extension portion 900, the second extension portion 901, the first grid plate 301, and the second grid plate 401 are respectively in a vertical state.

The outer shell 90 is further provided with a first protrusion portion 3 and a second protrusion portion 4 on two opposite sides of the outer shell 90, the first protrusion portion 3 is located on a side, corresponding to the first buckle 12, of the outer shell 90, the second protrusion portion 4 is located on a side, corresponding to the second buckle 13, of the outer shell 90, the first concave portion 30 is concavely arranged on the first protrusion portion 3, the second concave portion 40 is concavely arranged on the second protrusion portion 4, the first silencing member 21 is located inside the first protrusion portion 3, and the second silencing member 22 is located inside the second protrusion portion 4. With such design, internal and external spaces of the first protrusion portion 3 and the second protrusion portion 4 are fully utilized, the first silencing member 21 and the second silencing member 22 is able to be conveniently placed, and meanwhile, a space utilization efficiency is also promoted.

The first protrusion portion 3 is provided with a first outer side wall 31 and a second outer side wall 32 on two opposite sides thereof, the first outer side wall 31 and the second outer side wall 32 are located on two opposite sides of the air inlet window 300, the first silencing member 21 is located between the first outer side wall 31 and the second outer side wall 32, the first silencing member 21 is plate-shaped facing the air inlet window 300, one side edge of the first silencing member 21 abuts on the first outer side wall 31 (so that a tightness between the side edge and the first outer side wall 31 is enhanced, and a noise reduction effect is enhanced), and the other opposite side edge of the first silencing member 21 abuts on the second outer side wall 32 (so that a tightness between the side edge and the second outer side wall 31 is enhanced, and a noise reduction effect is enhanced); the second protrusion portion 4 is provided with a third outer side wall 41 and a fourth outer side wall 42 on two opposite sides thereof, the third outer side wall 41 and the fourth outer side wall 42 are located on two opposite sides of the air outlet window 400, the second silencing member 22 is located between the third outer side wall 41 and the fourth outer side wall 42, the second silencing member 22 is plate-shaped facing the air outlet window 400, one side edge of the second silencing member 22 abuts on the third outer side wall 41 (so that a tightness between the side edge and the third outer side wall 41 is enhanced, and a noise reduction effect is enhanced), and the other opposite side edge of the second silencing member 22 abuts on the fourth outer side wall 42 (so that a tightness between the side edge and the fourth outer side wall 42 is enhanced, and a noise reduction effect is enhanced); and the first outer side wall 31 and the second outer side wall 32 further enhance a position stability of the first silencing member 21, and the third outer side wall 41 and the fourth outer side wall 42 further enhance a position stability of the second silencing member 22.

The machine head 9 is further provided with a lower cover 98, the lower cover 98 covers an upper end of the dust collecting barrel 11, the first buckle 12 is buckled at an edge of one side of the lower cover 98, the second buckle 13 is buckled at an edge of the other opposite side of the lower cover 98, the outer shell 90 is mounted on an upper side of the lower cover 98, the first protrusion portion 3 is further provided with a first top wall 33 located on its top, the first top wall 33 is integrally connected to a top end of the air inlet window 300, a top end of the first outer side wall 31, and a top end of the second outer side wall 32; an upper side edge of the first silencing member 21 abuts on the first top wall 33, and a bottom side edge of the first silencing member 21 abuts on the lower cover 98; and the second protrusion portion 4 is further provided with a second top wall 43 located on its top, the second top wall 43 is integrally connected to a top end of the air outlet window 400, a top end of the third outer side wall 41, and a top end of the fourth outer side wall 42; an upper side edge of the second silencing member 22 abuts on the second top wall 43, and a bottom side edge of the second silencing member 22 abuts on the lower cover 98. The design is beneficial for increasing a covering range of the first silencing member 21 and the second silencing member 22 to promote a noise reduction performance, and is also conducive to position stabilities of the first silencing member 21 and the second silencing member 22.

The first silencing member 21 is vertical to the first outer side wall 31 and the second outer side wall 32, the second silencing member 22 is vertical to the third outer side wall 41 and the fourth outer side wall 42, the first silencing member 21 and the second silencing member 22 are respectively upright arranged on the upper side of the lower cover 98, and a lower end of the first outer side wall 31, a lower end of the second outer side wall 32, a lower end of the third outer side wall 41, a lower end of the fourth outer side wall 42, a lower end of the air inlet window 300, and a lower end of the air outlet window 400 are respectively attached to the lower cover 98. The first silencing member 21 and the air inlet window 300 are located on a lower side of the first top wall 33, the second silencing member 22 and the air outlet window 400 are located on a lower side of the second top wall 43, the first extension portion 900 is located inside the first protrusion portion 3, the first extension portion 900 integrally extends downwards from the first top wall 33, the second extension portion 901 is located inside the second protrusion portion 4, and the second extension portion 901 integrally extends downwards from the second top wall 43. The first extension portion 900 is located between the first outer side wall 31 and the second outer side wall 32, and the second extension portion 901 is located between the third outer side wall 41 and the fourth outer side wall 42.

The motor 20 is provided with a heat dissipation air inlet 200 and a heat dissipation air outlet 201, a heat dissipation air duct 92 is formed in the machine head 9, the heat dissipation airflow enters the motor 20 from the heat dissipation air inlet 200 and is exhausted out of the motor 20 from the heat dissipation air outlet 201 and flows into the heat dissipation air duct 92, an end of the heat dissipation air duct 92 is provided with an air outlet 920, and the air outlet window 400 is located at a downstream of the air outlet 920 of the heat dissipation air duct 92. The second silencing member 22 is located between the air outlet 920 of the heat dissipation air duct 92 and the air outlet window 400. The heat dissipation air duct 92 is in fluid communication between the heat dissipation air outlet 201 of the motor 20 and an interior of the second protrusion portion 4.

The air outlet 920 of the heat dissipation air duct 92 and the air outlet window 400 are located on two opposite sides of the second protrusion portion 4, the air outlet 920 of the heat dissipation air duct 92 faces the air outlet window 400, and the air outlet 920 of the heat dissipation air duct 92 directly communicates with the interior of the second protrusion portion 4. Such design is simple and practical, which is conducive to improving an air outlet efficiency.

The machine head 9 is provided with a heat dissipation air hood 93 configured for forming the heat dissipation air duct 92, the heat dissipation air hood 93 is located on an upper side of the heat dissipation air duct 92, the air outlet 920 of the heat dissipation air duct 92 is located at an end, relatively close to the air outlet window 400, of the heat dissipation air hood 93, the heat dissipation air hood 93 is provided with a shield plate 930, the heat dissipation air inlet 200 of the motor 20 is located on a top of the motor 20, the shield plate 930 is located above the heat dissipation air inlet 200, a projection formed by vertical downward projection of the shield plate 930 completely covers the heat dissipation air inlet 200, so that the shield plate 930 is able to effectively shield and protect the heat dissipation air inlet 200 to prevent impurities from entering the heat dissipation air inlet 200.

The machine head 9 is further provided with a vibration damping seal washer 94, the heat dissipation air hood 93 is provided with a sleeve ring portion 931 and a vent 932, the shield plate 930 is located on an upper side of the sleeve ring portion 931, the vent 932 is formed between the sleeve ring portion 931 and the shield plate 930, the vibration damping seal washer 94 is sleeved on an upper end of the motor 20 and is sealed between a peripheral edge of the upper end of the motor 20 and the sleeve ring portion 931 for isolating the heat dissipation air inlet 200 of the motor 20 from the heat dissipation air duct 92, so as to avoid that part of the heat dissipation airflow does not flow into the heat dissipation air inlet 200, but flows into the heat dissipation air duct 92 from a position between the peripheral edge of the upper end of the motor 20 and the sleeve ring portion 931; and the heat dissipation airflow flows toward the heat dissipation air inlet 200 through the vent 932.

The machine head 9 is further provided with a third silencing member 95, the third silencing member 95 is plate-shaped abutting on an inner surface of the outer shell 90 and is located above the heat dissipation air hood 93, and the shield plate 930 upwardly abuts on the third silencing member 95, so that the shield plate 930 effectively separates the heat dissipation air inlet 200 from the third silencing member 95. The shield plate 930 is disc-shaped, and the third silencing member 95 is glued to the inner surface of the outer shell 90. The first silencing member 21, the second silencing member 22 and the third silencing member 95 are able to be made of common silencing sponge, such as polyether sponge, felt, polyurethane sponge, rock wool, glass wool, etc.

The machine head 9 is further provided with an exhaust air hood 96 and an impeller, the impeller is located below the motor 20, and the impeller rotates under driving of the motor 20 to form a suction airflow to suck garbage; and the lower cover 98 is provided with a suction air opening 980, and the suction airflow flows to the impeller through the suction air opening 980. The exhaust air hood 96 is located on the upper side of the lower cover 98, an exhaust air duct 99 is formed between the exhaust air hood 96 and the lower cover 98, the exhaust air duct 99 surrounds an axis of a rotating shaft (not shown in the figure) of the motor 20, and the airflow exhausted by the impeller flows through the exhaust air duct 99; and the lower cover 98 is provided with a first part 981 located on a bottom side of the first concave portion 30, and a second part 982 located on a bottom side of the second concave portion 40, the first buckle 12 is buckled on the first part 981, and the second buckle 13 is buckled on the second part 982. The motor 20 is located in the middle area of the exhaust air hood 96, the impeller is fixed on the rotating shaft of the motor 20, and the exhaust air duct 99 is a spiral air duct. The first part 981 is provided with a first stop rib 983, the first stop rib 983 protrudes inwards the first concave portion 30, and the first stop rib 983 is configured to fit with the first buckle 12 to prevent a buckling fit between the first buckle 12 and the first part 981 from being disengaged; and the second part 982 is provided with a second stop rib 984, the second stop rib 984 protrudes inwards the second concave portion 40, and the second stop rib 984 is configured to fit with the second buckle 13 to prevent a buckling fit between the second buckle 13 and the second part 982 from being disengaged.

The vacuum cleaner is further provided with an impeller shell 971, the impeller is located in the impeller shell 971, the impeller shell 971 is located between the exhaust air hood 96 and the lower cover 98, the impeller shell 971 is provided with a plurality of air exhaust openings 972 located in a peripheral direction of the impeller shell 971, and the airflow exhausted by the impeller enters the exhaust air duct 99 through the plurality of air exhaust openings 972. The exhaust air hood 96 is locked to the lower cover 98 by screws, and the outer shell 90 is locked to the lower cover 98 by screws. During assembling, first, the first silencing member 21, the second silencing member 22 and the third silencing member 95 are fixed to the outer shell 90, and then the aforementioned four are integrally mounted to the lower cover 98. The heat dissipation air hood 93 is located on an upper side of the exhaust air hood 96, and the heat dissipation air duct 92 is formed among the heat dissipation air hood 93, the exhaust air hood 96 and the lower cover 98; and the heat dissipation air hood 93 and the exhaust air hood 96 are located between the outer shell 90 and the lower cover 98, and the outer shell 90 is located on the upper side of the lower cover 98 and covers the heat dissipation air hood 93 and the exhaust air hood 96.

The heat dissipation air outlet 201 of the motor 20 is located on the bottom side of the motor 20, the heat dissipation air duct 92 includes an annular part 921 surrounding the motor 20, and a lead-out part 922 located at a downstream of the annular part 921, and with respect to the air outlet window 400, the air outlet 920 of the heat dissipation air duct 92 is located at an end, relatively close to the air outlet window 400, of the lead-out part 922; and with respect to the annular part 921, the air outlet 920 of the heat dissipation air duct 92 is located at an end, relatively away from the annular part 921, of the lead-out part 922.

The first concave portion 30 is formed with a first groove 302, the second concave portion 40 is formed with a second groove 402, the first buckle 12 is at least partially accommodated in the first groove 302, the second buckle 13 is at least partially accommodated in the second groove 402, the first groove 302 is located on a side, facing the first buckle 12, of the air inlet window 300, the second groove 402 is located on a side, facing the second buckle 13, of the air outlet window 400, the air inlet window 300 directly communicates with an interior of the machine head 9 and the first groove 302, and the air outlet window 400 directly communicates with the interior of the machine head 9 and the second groove 402. The air inlet window 300 directly communicates with an interior of the first protrusion portion 3 and the first groove 302, and the air outlet window 400 directly communicates with the interior of the second protrusion portion 4 and the second groove 402. The first groove 302 and the second groove 402 extend along an up-down direction, the first concave portion 30 is provided with a first vertical side wall 303 and a second vertical side wall 304, the second concave portion 40 is provided with a third vertical side wall 403 and a fourth vertical side wall 404, the air inlet window 300 is connected between the first vertical side wall 303 and the second vertical side wall 304, the first vertical side wall 303, the air inlet window 300 and the second vertical side wall 304 are connected together to form the first groove 302, the air outlet window 400 is connected between the third vertical side wall 403 and the fourth vertical side wall 404, and the third vertical side wall 403, the air outlet window 400 and the fourth vertical side wall 404 are connected together to form the second groove 402.

In the embodiment, the first buckle 12 and the second buckle 13 are basically the same in structure and are able to be used interchangeably; the first buckle 12 is pivotally connected on one side of the dust collecting barrel 11, and the second buckle 13 is pivotally connected on the other opposite side of the dust collecting barrel 11; the first buckle 12 is pivotally connected to one side of the dust collecting barrel 11 by means of fit of a first shaft part (not shown in the figure) on one side of the dust collecting barrel 11 and a first shaft hole (not shown in the figure) of the first buckle 12; the second buckle 13 is pivotally connected to other opposite side of the dust collecting barrel 11 by means of fit of a second shaft part (not shown in the figure) on the other opposite side of the dust collecting barrel 11 and a second shaft hole 131 of the second buckle 13; the first buckle 12 is provided with a first main board portion 120, the second buckle 13 is provided with a second main board portion 130, the first main board portion 120 faces the air inlet window 300, and the second main board portion 130 faces the air outlet window 400; and the motor 20 is provided with a heat dissipation fan 202, the heat dissipation fan 202 is located in the heat dissipation air inlet 200, the heat dissipation fan 202 rotates to form the heat dissipation airflow, the heat dissipation airflow enters the first protrusion portion 3 through the first groove 302 and the air inlet window 300 in sequence and passes through the first silencing member 21 inside the first protrusion portion 3, then the heat dissipation airflow flows to the vent 932 and then enters the motor 20 through the heat dissipation air inlet 200, the heat dissipation airflow downwardly passes through the interior of the motor 20 from the heat dissipation air inlet 200 and flows out of the motor 20 from the heat dissipation air outlet 201 on the bottom side of the motor 20; after flowing out from the heat dissipation air outlet 201, the heat dissipation airflow enters the annular part 921 of the heat dissipation air duct 92, the heat dissipation airflow upwardly flows to an upper part of the annular part 921 and is converged into the lead-out part 922 of the heat dissipation air duct 92, and is exhausted out of the heat dissipation air duct 92 through the air outlet 920 of the heat dissipation air duct 92 and enters the second protrusion portion 4, and the heat dissipation airflow passes through the second silencing member 22 and is exhausted through the air outlet window 400. The first main board portion 120 is opposite to the air inlet window 300 at an interval, and an upper end of the first buckle 12 and an upper end of the first concave portion 30 are surrounded together to form a first opening 70; and the second main board portion 130 is opposite to the air outlet window 400 at an interval, an upper end of the second buckle 13 and an upper end of the second concave portion 40 are surrounded together to form a second opening 71, the first opening 70 and the second opening 71 face upwards respectively, and at least part of the heat dissipation airflow exhausted through the air outlet window 400 flows upwards out of the second opening 71, so as to be converged upwards into the external environment of the vacuum cleaner.

The vacuum cleaner is further provided with a filter 15, and the filter 15 is mounted on a bottom side of the lower cover 98; the dust collecting barrel 11 is provided with a dust suction end opening 110, when the vacuum cleaner sucks garbage, the garbage enters the dust collecting barrel 11 from the dust suction end opening 110 with suction airflow, then the suction airflow passes through the filter 15 to be filtered by the filter 15, the filtered suction airflow flows to the impeller through the suction air opening 980, and the airflow exhausted by the impeller flows into the exhaust air duct 99 and is exhausted out of the vacuum cleaner through an air exhaust window 902 on a rear side of the outer shell 90.

What is claimed is:

1. A vacuum cleaner, comprising a dust collecting barrel, a machine head, a first buckle and a second buckle, the dust collecting barrel and the machine head are detachably assembled together by the first buckle and the second buckle, the machine head is provided with a motor, an air inlet window and an air outlet window, a first silencing member which is breathable and corresponds to the air inlet window and a second silencing member which is breathable and corresponds to the air outlet window, the air inlet window and the air outlet window are located on left and right sides of the machine head, a heat dissipation airflow for the motor enters the machine head through the air inlet window located on one of left and right sides of the machine head and is exhausted out of the machine head through the air outlet window located on the other of left and right sides of the machine head, and the heat dissipation airflow passes through the air inlet window, the first silencing member, an interior of the motor, the second silencing member and the air outlet window in sequence.

2. The vacuum cleaner according to claim 1, wherein the first buckle and the second buckle are located on left and right sides of the machine head, the machine head is further provided with a first concave portion corresponding to the first buckle and a second concave portion corresponding to the second buckle, the first concave portion and the second concave portion are located on left and right sides of the machine head, the first buckle is at least partially accommodated in the first concave portion, the second buckle is at least partially accommodated in the second concave portion, the first concave portion is provided with the air inlet window, the second concave portion is provided with the air outlet window, the first silencing member is located on a side, facing away from the first buckle, of the air inlet window, and the second silencing member is located on a side, facing away from the second buckle, of the air outlet window.

3. The vacuum cleaner according to claim 2, wherein the first silencing member is plate-shaped and is shielded on an inner side of the air inlet window, and the second silencing member is plate-shaped and is shielded on an inner side of the air outlet window.

4. The vacuum cleaner according to claim 2, wherein the machine head is further provided with an outer shell and a handle, the handle is connected to the outer shell, the first concave portion and the second concave portion are parts of the outer shell respectively, the air inlet window and the air outlet window are located on left and right sides of the outer shell, the outer shell is provided with a first extension portion configured for fixing the first silencing member and a second extension portion configured for fixing the second silencing member, the first extension portion and the air inlet window clamp the first silencing member, and the second extension portion and the air outlet window clamp the second silencing member.

5. The vacuum cleaner according to claim 42, wherein the air inlet window is provided with a plurality of first grid plates in parallel, the plurality of first grid plates are located on the side, facing away from the first buckle, of the air inlet window, the air outlet window is provided with a plurality of second grid plates in parallel, the plurality of second grid plates are located on the side, facing away from the second buckle, of the air outlet window, the first extension portion and the plurality of first grid plates clamp the first silencing member, and the second extension portion and the plurality of second grid plates clamp the second silencing member.

6. The vacuum cleaner according to claim 2, wherein the machine head is further provided with an outer shell, the outer shell is provided with a first protrusion portion and a second protrusion portion on left and right sides of the outer shell, the first protrusion portion is located on a side, corresponding to the first buckle, of the outer shell, the second protrusion portion is located on a side, corresponding to the second buckle, of the outer shell, the first concave portion is concavely arranged on the first protrusion portion, the second concave portion is concavely arranged on the second protrusion portion, the first silencing member is located inside the first protrusion portion, and the second silencing member is located inside the second protrusion portion.

7. The vacuum cleaner according to claim 6, wherein the first protrusion portion is provided with a first outer side wall and a second outer side wall on front and rear sides thereof, the first silencing member is located between the first outer side wall and the second outer side wall, the first silencing member is plate-shaped facing the air inlet window, a side edge of the first silencing member abuts on the first outer side wall, and an opposite side edge of the first silencing member abuts on the second outer side wall; and the second protrusion portion is provided with a third outer side wall and a fourth outer side wall on front and rear sides thereof, the second silencing member is located between the third outer side wall and the fourth outer side wall, the second silencing member is plate-shaped facing the air outlet window, one side edge of the second silencing member abuts on the third outer side wall, and the other opposite side edge of the second silencing member abuts on the fourth outer side wall.

8. The vacuum cleaner according to claim 7, wherein the first outer side wall and the second outer side wall are located on front and rear sides of the air inlet window, the third outer side wall and the fourth outer side wall are located on front and rear sides of the air outlet window, the machine head is further provided with a lower cover, the lower cover covers an upper end of the dust collecting barrel, the first buckle is buckled at an edge of one side of the lower cover, the second buckle is buckled at an edge of the other opposite side of the lower cover, the outer shell is mounted at an upper side of the lower cover, the first protrusion portion is further provided with a first top wall located on its top, the first top wall is integrally connected to a top end of the air inlet window, a top end of the first outer side wall, and a top end of the second outer side wall; an upper side edge of the first silencing member abuts on the first top wall, and a bottom side edge of the first silencing member abuts on the lower cover; and the second protrusion portion is further provided with a second top wall located on its top, the second top wall is integrally connected to a top end of the air outlet window, a top end of the third outer side wall, and a top end of the fourth outer side wall; an upper side edge of the second silencing member abuts on the second top wall, and a bottom side edge of the second silencing member abuts on the lower cover; and/or
the first silencing member and the second silencing member are respectively upright arranged on the upper side of the lower cover, and a lower end of the first outer side wall, a lower end of the second outer side wall, a lower end of the third outer side wall, a lower end of the fourth outer side wall, a lower end of the air inlet window, and a lower end of the air outlet window are respectively attached to the lower cover.

9. (canceled)

10. The vacuum cleaner according to claim 6, wherein the first protrusion portion is further provided with a first top wall located on its top, the second protrusion portion is further provided with a second top wall located on its top, the first silencing member and the air inlet window are located on a lower side of the first top wall, the second silencing member and the air outlet window are located on a lower side of the second top wall, the outer shell is provided with a first extension portion configured for fixing the first silencing member and a second extension portion configured for fixing the second silencing member, the first extension portion is located inside the first protrusion portion and integrally extends downwards from the first top wall, and the second extension portion is located inside the second protrusion portion and integrally extends downwards from the second top wall.

11. The vacuum cleaner according to claim 1, wherein the first buckle and the second buckle are located on left and right sides of the machine head, the machine head is further provided with a first concave portion corresponding to the first buckle and a second concave portion corresponding to the second buckle, the first concave portion and the second concave portion are located on left and right sides of the machine head, the first buckle is at least partially accommodated in the first concave portion, the second buckle is at least partially accommodated in the second concave portion, the first concave portion is provided with the air inlet window, the second concave portion is provided with the air outlet window, the motor is provided with a heat dissipation air inlet and a heat dissipation air outlet, a heat dissipation air duct is formed in the machine head, the heat dissipation airflow enters the motor through the heat dissipation air inlet and is exhausted out of the motor through the heat dissipation air outlet and flows into the heat dissipation air duct, an end of the heat dissipation air duct is provided with an air outlet, and the air outlet window is located at a downstream of the air outlet of the heat dissipation air duct.

12. The vacuum cleaner according to claim 11, wherein the machine head is further provided with a first protrusion portion corresponding to the first buckle, and a second protrusion portion corresponding to the second buckle, the first concave portion is concavely arranged on the first protrusion portion, the second concave portion is concavely arranged on the second protrusion portion, and the heat dissipation air duct is in fluid communication between the heat dissipation air outlet of the motor and an interior of the second protrusion portion; and/or
the air outlet of the heat dissipation air duct and the air outlet window are located on left and right sides of the second protrusion portion, the air outlet of the heat dissipation air duct is toward the air outlet window, the air outlet of the heat dissipation air duct directly communicates with the interior of the second protrusion portion, and the second silencer is arranged between the air outlet window and the air outlet of the heat dissipation air duct; the first silencing member is located inside the first protrusion portion, and the second silencing member is located inside the second protrusion portion; and/or
the heat dissipation air outlet of the motor is located on a bottom side of the motor, the heat dissipation air duct comprises an annular part surrounding the motor, and a lead-out part located at a downstream of the annular part, and with respect to the air outlet window, the air outlet of the heat dissipation air duct is located at an end, relatively close to the air outlet window, of the lead-out part; and with respect to the annular part, the air outlet of the heat dissipation air duct is located at an end, relatively away from the annular part, of the lead-out part.

13. (canceled)

14. The vacuum cleaner according to claim 11, wherein the machine head is provided with a heat dissipation air hood configured for forming the heat dissipation air duct, the air outlet of the heat dissipation air duct is located at an end, relatively close to the air outlet window, of the heat dissipation air hood, the heat dissipation air hood is provided with a shield plate, the heat dissipation air inlet of the motor is located on a top of the motor, and the shield plate is located above the heat dissipation air inlet.

15. The vacuum cleaner according to claim 14, wherein the machine head is further provided with a vibration damping seal washer, the heat dissipation air hood is provided with a sleeve ring portion and a vent, the shield plate is located on an upper side of the sleeve ring portion, the vent is formed between the sleeve ring portion and the shield plate, the vibration damping seal washer is sleeved on an upper end of the motor and is sealed between a peripheral edge of the upper end of the motor and the sleeve ring portion for isolating the heat dissipation air inlet of the motor from the heat dissipation air duct, and the heat dissipation airflow flows toward the heat dissipation air inlet through the vent; and/or
the machine head is further provided with an outer shell, a third silencing member, a first concave portion corresponding to the first buckle, and a second concave portion corresponding to the second buckle, the first concave portion and the second concave portion are respectively parts of the outer shell, the heat dissipation air hood is located in the outer shell, the third silencing member is plate-shaped abutting on an inner surface of the outer shell and is located above the heat dissipation air hood, the shield plate upwardly abuts on the third silencing member, and a projection formed by vertical downward projection of the shield plate completely covers the heat dissipation air inlet.

16. (canceled)

17. The vacuum cleaner according to claim 11, wherein the machine head is further provided with a lower cover, an exhaust air hood, an impeller, the impeller is located below the motor, the impeller rotates under driving of the motor to form a suction airflow, the exhaust air hood is located on an upper side of the lower cover, an exhaust air duct is formed between the exhaust air hood and the lower cover, the exhaust air duct surrounds an axis of a rotating shaft of the motor, and an airflow exhausted by the impeller flows through the exhaust air duct; and the lower cover is provided with a first part located on a bottom side of the first concave portion, and a second part located on a bottom side of the second concave portion, the first buckle is buckled on the first part, and the second buckle is buckled on the second part.

18. The vacuum cleaner according to claim 17, wherein the first part is provided with a first stop rib, the first stop rib protrudes inwards the first concave portion, and the first stop rib is configured to fit with the first buckle to prevent a buckling fit between the first buckle and the first part from being disengaged; and the second part is provided with a second stop rib, the second stop rib protrudes inwards the second concave portion, and the second stop rib is configured to fit with the second buckle to prevent a buckling fit between the second buckle and the second part from being disengaged; and/or
the machine head is further provided with a heat dissipation air hood and an outer shell, the heat dissipation air hood is located on an upper side of the exhaust air hood, and the heat dissipation air duct is formed among the heat dissipation air hood, the exhaust air hood and the lower cover; and the first concave portion and the second concave portion are respectively parts of the outer shell, the heat dissipation air hood and the exhaust air hood are located between the outer shell and the lower cover, and the outer shell is located on the upper side of the lower cover and covers the heat dissipation air hood and the exhaust air hood.

19-20. (canceled)

21. The vacuum cleaner according to claim 12, wherein the first concave portion is formed with a first groove, the second concave portion is formed with a second groove, the first groove is located on a side, facing the first buckle, of the air inlet window, the second groove is located on a side, facing the second buckle, of the air outlet window, the air inlet window directly communicates with an interior of the first protrusion portion and the first groove, and the air outlet window directly communicates with an interior of the second protrusion portion and the second groove; and the heat dissipation airflow enters the first protrusion portion through the first groove and the air inlet window in sequence and passes through the first silencing member inside the first protrusion portion, the heat dissipation airflow downwardly passes through the interior of the motor from the heat dissipation air inlet and flows out of the motor from the heat dissipation air outlet on a bottom side of the motor; after flowing out from the heat dissipation air outlet, the heat dissipation airflow enters the annular part of the heat dissipation air duct, the heat dissipation airflow upwardly flows to an upper part of the annular part and is converged into the lead-out part of the heat dissipation air duct, and is exhausted out of the heat dissipation air duct through the air outlet of the heat dissipation air duct and enters the second protrusion portion, and the heat dissipation airflow passes through the second silencing member inside the second protrusion portion and is exhausted through the air outlet window.

22. The vacuum cleaner according to claim 1, wherein the air inlet window faces the first buckle, and the air outlet window faces the second buckle; the first buckle and the second buckle are located on left and right sides of the machine head, the machine head is further provided with a first concave portion corresponding to the first buckle and a second concave portion corresponding to the second buckle, the first concave portion and the second concave portion are located on left and right sides of the machine head, the first concave portion is provided with the air inlet window, the second concave portion is provided with the air outlet window; the first concave portion is formed with a first groove, the second concave portion is formed with a second groove, the first buckle is at least partially accommodated in the first groove, the second buckle is at least partially accommodated in the second groove, the first groove is located on a side, facing away from the first silencing member, of the air inlet window, the second groove is located on a side, facing away from the second silencing member, of the air outlet window, the air inlet window directly communicates with an interior of the machine head and the first groove, and the air outlet window directly communicates with the interior of the machine head and the second groove.

23. The vacuum cleaner according to claim 22, wherein the machine head is further provided with an outer shell, the outer shell is further provided with a first protrusion portion and a second protrusion portion on front and rear sides of the outer shell, the first protrusion portion is located on a side, corresponding to the first buckle, of the outer shell, the second protrusion portion is located on a side, corresponding to the second buckle, of the outer shell, the first concave portion is concavely arranged on the first protrusion portion, the second concave portion is concavely arranged on the second protrusion portion, the air inlet window directly communicates with an interior of the first protrusion portion and the first groove, and the air outlet window directly communicates with an interior of the second protrusion portion and the second groove; and/or
the motor is provided with a heat dissipation air inlet and a heat dissipation air outlet, a heat dissipation air duct is formed in the machine head, the heat dissipation airflow enters the first protrusion portion through the first groove and the air inlet window in sequence and passes through the first silencing member inside the first protrusion portion, the heat dissipation airflow enters the motor from the heat dissipation air inlet and is exhausted out of the motor from the heat dissipation air outlet and flows into the heat dissipation air duct, the heat dissipation airflow is exhausted out of the heat dissipation air duct through an air outlet of the heat dissipation air duct and enters the second protrusion portion, and the heat dissipation airflow passes through the second silencing member inside the second protrusion portion and is exhausted out of the machine head through the air outlet window.

24. The vacuum cleaner according to claim 22, wherein the first groove and the second groove extend along an up-down direction, the first concave portion is provided with a first vertical side wall and a second vertical side wall on front and rear sides thereof, the second concave portion is provided with a third vertical side wall and a fourth vertical side wall on front and rear sides thereof, the air inlet window is connected between the first vertical side wall and the second vertical side wall, the first vertical side wall, the air inlet window and the second vertical side wall are connected together to form the first groove, the air outlet window is connected between the third vertical side wall and the fourth vertical side wall, and the third vertical side wall, the air outlet window and the fourth vertical side wall are connected together to form the second groove.

25. (canceled)

26. The vacuum cleaner according to claim 22, wherein the motor is provided with a heat dissipation fan, and the heat dissipation fan rotates to form the heat dissipation airflow; the first buckle is pivotally connected on one side of the dust collecting barrel, the second buckle is pivotally connected on the other opposite side of the dust collecting barrel; the first buckle is partially accommodated in the first groove, the second buckle is partially accommodated in the second groove; the first buckle is provided with a first main board portion, the second buckle is provided with a second main board portion, the first main board portion faces the air inlet window, the first main board portion is opposite to the air inlet window at an interval, and an upper end of the first buckle and an upper end of the first concave portion are surrounded together to form a first opening; and the second main board portion faces the air outlet window, the second main board portion is opposite to the air outlet window at an interval, an upper end of the second buckle and an upper end of the second concave portion are surrounded together to form a second opening, the first opening and the second opening face upwards respectively, and at least part of the heat dissipation airflow exhausted through the air outlet window flows upwards out of the second opening.
